(19) United States
(12) Patent Application Publication
(10) Pub. No.: US 2012/0125169 A1
(43) Pub. Date: May 24, 2012

(54) SEMICONDUCTOR LIGHT-EMITTING DEVICE MEASUREMENT APPARATUS

(75) Inventor: Shuhei SUDA, Joyo-shi (JP)

(73) Assignee: SEIWA ELECTRIC MFG. CO., LTD., Joyo-shi (JP)

(21) Appl. No.: 13/300,224

(22) Filed: Nov. 18, 2011

(30) Foreign Application Priority Data
Nov. 19, 2010 (JP) 2010-258820

(51) Int. Cl. B26D 5/00; B23K 26/38

(52) U.S. Cl. 83/73; 219/121.67; 83/72

(57) ABSTRACT

A movable stage on which an LED chip is placed is moved in horizontal directions (for example, the x-axis direction and the y-axis direction) under the control of a position adjusting section. A probe needle is brought into contact with a bonding electrode on the surface of the LED chip to apply a desired voltage to the LED chip. A light detecting section detects light from the LED chip. An optical characteristic measuring section measures, based on the results of detection by the light detecting section, optical characteristics of the LED chip. A laser light source removes a part of the surface of the LED chip by laser light.

### CROSS-REFERENCE TO RELATED APPLICATION

This non-provisional application claims priority under 35 U.S.C. §119(a) on Patent Application No. 2010-258820 filed in Japan on Nov. 19, 2010, the entire contents of which are hereby incorporated by reference.

### BACKGROUND

1. Technical Field

The present invention relates to a semiconductor light-emitting device measurement apparatus for measuring optical characteristics of semiconductor light-emitting devices.

2. Description of Related Art

Light-emitting diodes (LEDs) have attracted attention as light sources because the LEDs consume less electric power and have longer life compared to conventionally used light sources, such as luminescent lamps and incandescent lamps, and have been used in a variety of fields, including lighting switches, backlight light sources, illumination light sources, and decoration of amusement appliance, as well as light sources for lighting.

Optical characteristics or electric characteristics of LED chips (semiconductor light-emitting devices) to be used for such light-emitting diodes are measurable by a light-emitting device measurement apparatus. For example, there is disclosed an optical characteristic measurement apparatus having detecting and measuring means, which places an LED chip on a stage, applies a given voltage to the LED chip by bringing a probe needle into contact with an electrode, detects irradiated light from the LED chip, and measures the optical characteristics (see Japanese Patent Application Laid-Open No. 2006-30135).

### SUMMARY OF THE INVENTION

A conventional optical characteristic measurement apparatus is capable of measuring optical characteristics or electric characteristics (characteristics) of each LED wafer or each LED chip, and, for example, capable of obtaining information about characteristic distribution in a wafer surface. However, since the characteristics of LED chips were unambiguously determined at the stage of manufacture of the LED chips, this apparatus merely confirms the characteristics of the manufactured LED chips. Meanwhile, there is a case where the characteristics of LED chips have values different from desired target values due to various reasons in the process of manufacturing the LED chips. If a measured characteristic is out of a tolerance range, the manufactured LED chips are useless, resulting in a problem of lower yield. There is also a demand for changing the characteristics of LED chips according to applications.

The present invention has been made with the aim of solving the above problems, and it is an object of the present invention to provide a semiconductor light-emitting device measurement apparatus capable of changing the characteristics of a semiconductor light-emitting device.

A semiconductor light-emitting device measurement apparatus according to the present invention is a semiconductor light-emitting device measurement apparatus having a measuring section for detecting light from a semiconductor light-emitting device and measuring optical characteristics, and characterized by comprising a removal processing section for removing a part of a surface of the semiconductor light-emitting device.

The semiconductor light-emitting device measurement apparatus according to the present invention is characterized by comprising a position adjusting section for adjusting, based on optical characteristics measured by the measuring section, a position to be removed by the removal processing section.

The semiconductor light-emitting device measurement apparatus according to the present invention is characterized by comprising a determination section for determining whether or not a difference between an optical characteristic measured by the measuring section and a given target value is within a threshold, wherein, when the determination section determines that the difference is not within the threshold, the position adjusting section adjusts a position to be removed, according to the difference, and the removal processing section removes a part of a surface of the semiconductor light emitting device, according to the position adjusted by the position adjusting section, and, finishes removing when the determination section determines that the difference is within the threshold.

The semiconductor light-emitting device measurement apparatus according to the present invention is characterized in that the removal processing section removes any of a plurality of wiring layers connecting a semiconductor light-emitting layer of the semiconductor light-emitting device and a resistive layer formed to be connected in series with the semiconductor light-emitting layer.

The semiconductor light-emitting device measurement apparatus according to the present invention is characterized in that the removal processing section removes a part of a resistive layer formed to be connected in series with a semiconductor light-emitting layer of the semiconductor light-emitting device.

The semiconductor light-emitting device measurement apparatus according to the present invention is characterized in that the removal processing section is a laser light source for irradiating laser light.

The semiconductor light-emitting device measurement apparatus according to the present invention is characterized in that the position adjusting section is a movable mirror for adjusting an irradiation direction of laser light, or a movable base for placing the semiconductor light-emitting device thereon.

The semiconductor light-emitting device measurement apparatus according to the present invention is characterized in that the removal processing section is a cutting tool having a cutting needle.

The semiconductor light-emitting device measurement apparatus according to the present invention is characterized in that the position adjusting section is a movable base for placing the semiconductor light-emitting device thereon.

The semiconductor light-emitting device measurement apparatus according to the present invention is characterized by comprising a stratification section for stratifying the semiconductor light-emitting device, based on optical characteristics measured by the measuring section.

According to the present invention, the semiconductor light-emitting device measurement apparatus comprises a removal processing section for removing a part of a surface of a semiconductor light-emitting device. For example, the semiconductor light-emitting device is fabricated so that a semiconductor layer comprising a p-type semiconductor layer and an n-type semiconductor layer and a resistive layer comprising an n-type semiconductor layer are connected in series and bonding electrodes are provided at both ends of a series circuit. By removing a part of the resistive layer with the removal processing section, the resistance of the resistive layer is changed to adjust a current flowing in the semiconductor layer, and the quantity of light to be emitted from the semiconductor light-emitting device is also adjusted. It is thus possible to change the optical characteristics or electric characteristics of the semiconductor light-emitting device.

According to the present invention, the semiconductor light-emitting device measurement apparatus comprises a position adjusting section for adjusting, based on optical characteristics measured by the measuring section, the position to be removed by the removal processing section. For example, when the quantity of light from the semiconductor light-emitting device is large, the position to be removed by the removal processing section is changed to increase the resistance of the resistive layer, and consequently a current flowing in the semiconductor layer is reduced and the quantity of light is decreased. It is thus possible to change the characteristics while measuring the characteristics of the semiconductor light-emitting device.

According to the present invention, the semiconductor light-emitting device measurement apparatus comprises a determination section for determining whether or not the difference between an optical characteristic measured by the optical characteristic measuring section and a given target value is within a threshold, and, when the determination section determines that the difference is not within the threshold, the position adjusting section adjusts the position to be removed, according to the difference. The removal processing section removes a part of a surface of the semiconductor light-emitting device according to the position adjusted by the position adjusting section, and finishes removing when the determination section determines that the difference is within the threshold. For instance, before removing a part of the resistive layer by the removal processing section, when an optical characteristic (such as, for example, light quantity) of the semiconductor light-emitting device is measured, and, if the difference between the measured light quantity and a target value exceeds a threshold, the position to be removed is adjusted according to the difference. The adjustment of the position means adjusting, for example, the length or the area of a portion to be removed, or the number of portions to be removed. When the difference between the measured light quantity and the target value falls within the threshold, removing is finished. It is thus possible to set the characteristics of the semiconductor light-emitting device to desired values.

According to the present invention, the removal processing section removes any of wiring layers connecting the semiconductor light-emitting layer of the semiconductor light-emitting device and the resistive layer formed to be connected in series with the semiconductor light-emitting layer. Consequently, the path of the current flowing in the resistive layer is changed, and the quantity of light is adjusted by changing the resistance of the resistive layer.

According to the present invention, the removal processing section removes a part of the resistive layer formed to be connected in series with the semiconductor light-emitting layer of the semiconductor light-emitting device. Therefore, the quantity of light is adjusted by changing the resistance of the resistive layer.

According to the present invention, the removal processing section is a laser light source for irradiating laser light. With laser light, it is possible to remove a part of the surface (resistive layer) of the semiconductor light-emitting device until the substrate is exposed.

According to the present invention, the position adjusting section is a movable mirror for adjusting an irradiation direction of laser light, or a movable base for placing the semiconductor light-emitting device thereon. With this, it is possible to remove a desired position on the surface of the semiconductor light-emitting device.

According to the present invention, the removal processing section is a cutting device having a cutting needle. With the cutting needle, it is possible to remove a part of the surface (resistive layer) of the semiconductor light-emitting device until the substrate is exposed.

According to the present invention, the position adjusting section is a movable base for placing the semiconductor light-emitting device thereon. With this, it is possible to remove a desired position on the surface of the semiconductor light-emitting device.

According to the present invention, the semiconductor light-emitting device measurement apparatus comprises a stratification section for stratifying a semiconductor light-emitting device on the basis of optical characteristics measured by the measuring section. Thus, even when the optical characteristics are changed while measuring the optical characteristics, semiconductor light-emitting devices with similar optical characteristics are classified into one group, while semiconductor light-emitting devices with different optical characteristics are distinguished.

According to the present invention, the semiconductor light-emitting device comprises a removal processing section for removing a part of the surface of a semiconductor light-emitting device, and therefore it is possible to change the optical characteristics or electric characteristics of the semiconductor light-emitting device.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram illustrating one example of the configuration of a semiconductor light-emitting device measurement apparatus according to Embodiment 1;

FIG. 2 is a schematic view illustrating one example of the planar structure of an LED chip;

FIG. 3 is an explanatory view illustrating the circuit structure of the LED chip;

FIG. 4 is a schematic view illustrating another example of the planar structure of an LED chip;

FIG. 5 is an explanatory view illustrating the circuit structure of the LED chip; and

FIG. 6 is a block diagram illustrating one example of the configuration of a semiconductor light-emitting device measurement apparatus according to Embodiment 2.

### DETAILED DESCRIPTION

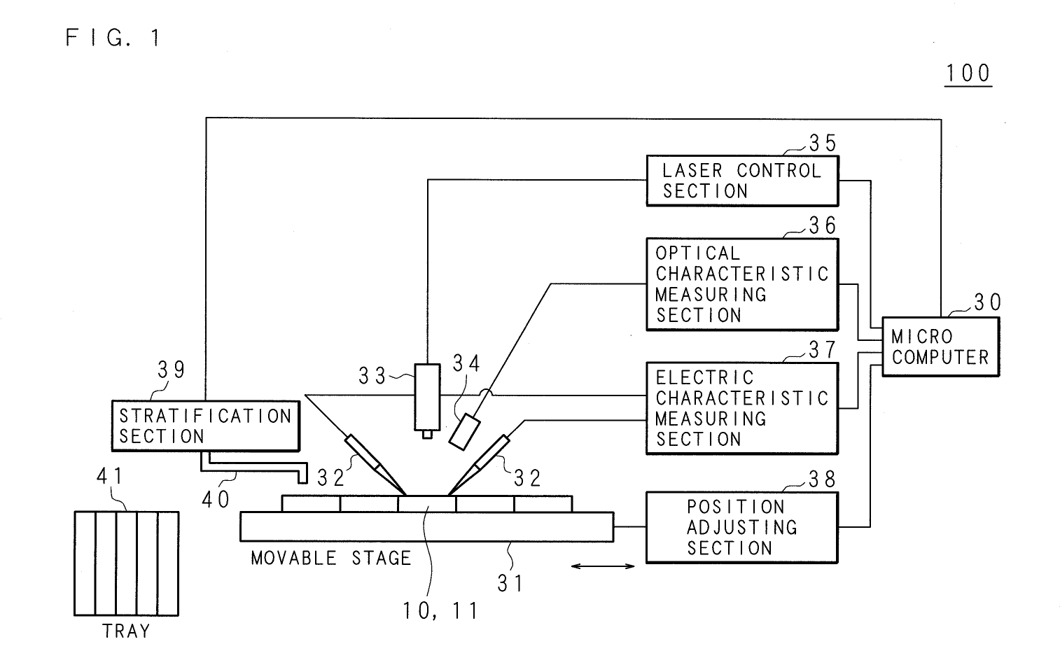

The following description will explain the present invention, based on the drawings illustrating some embodiments thereof. FIG. 1 is a block diagram illustrating one example of the configuration of a semiconductor light-emitting device measurement apparatus 100 according to Embodiment 1. The semiconductor light-emitting device measurement apparatus 100 comprises a microcomputer 30 for controlling the entire operations of the apparatus. The microcomputer 30 controls the operations of a laser control section 35, an optical characteristic measuring section 36, an electric characteristic measuring section 37, a position adjusting section 38, a stratification section 39, etc.

A movable stage 31 functions as a movable base for placing LED chips (semiconductor light-emitting devices) 10 and 11 thereon. A plurality of LED chips (semiconductor light-emitting devices) 10 and 11 mounted on a sheet, or a wafer comprising the LED chips 10 and 11, are placed on the movable stage 31, and the movable stage 31 is moved in horizontal directions (for example, the x-axis direction and the y-axis direction) under the control of the position adjusting section 38.

A probe needle 32 is brought into contact with bonding electrodes formed on the surfaces of the LED chips 10 and 11a and applies a given voltage (for example, 0V-10V) to the LED chips 10 and 11.

The electric characteristic measuring section 37 is capable of measuring electric characteristics, such as a forward voltage, a forward current and a resistance, while the given voltage is being applied to the LED chips 10 and 11. The electric characteristic measuring section 37 outputs the measured electric characteristics to the microcomputer 30.

A laser light source 33 performs a function as a removal processing section for removing a part of the surfaces (resistive layers) of the LED chips 10 and 11. For the laser light source 33, a YAG laser, or a laser light source which is generally used for processing, is used.

The laser control section 35 adjusts ON/OFF of the laser light source 33 and outputting of laser light under the control of the microcomputer 30.

A light detecting section 34 detects light from the LED chips 10 and 11. The light detecting section 34 comprises an optical fiber arranged to face the LED chips 10 and 11 on the movable stage, and a light receiving section provided on an end of the optical fiber. The light detecting section 34 outputs the detection results to the optical characteristic measuring section 36.

The optical characteristic measuring section 36 measures, based on the detection results from the light detecting section 34, optical characteristics of the LED chips 10 and 11. The optical characteristics to be measured include light quantity characteristics, such as brightness (mcd), power (mW) and a spectrum integral value, and wave length characteristics, such as a wavelength, chromaticity, and a half band width.

The stratification section 39 includes a suction section 40 for sucking the LED chips 10 and 11, sorts the LED chips 10 and 11 into classes according to the measurement results of the optical characteristics or electric characteristics of the LED chips 10 and 11 under the control of the microcomputer 30, and stores the LED chips 10 and 11 in a tray 41 in a sorted manner.

The position adjusting section 38 adjusts the position of a portion to be removed by the laser light source 33 by adjusting the position of the movable stage 31. Instead of the structure where the position of a portion to be removed is adjusted by the movable stage 31, if the laser light source 33 is provided with a movable mirror and a fine adjustment is made to the irradiation direction of laser light, it is also possible to adjust the position of a portion of the surfaces (resistive layers) of the LED chips 10 and 11 to be removed.

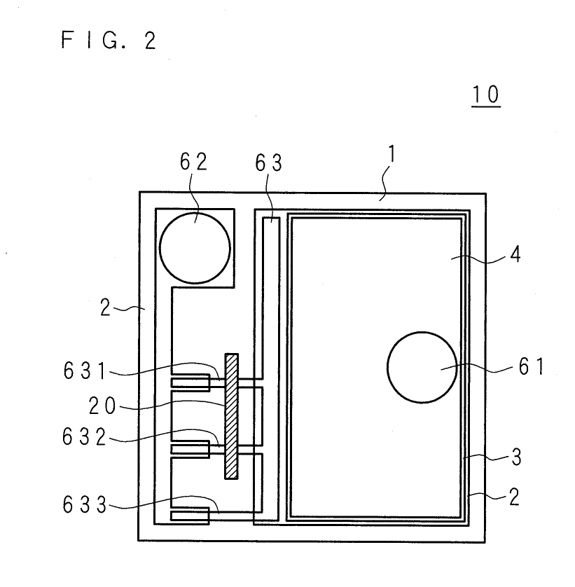

FIG. 2 is a schematic view illustrating one example of the planar structure of the LED chip 10. The LED chip 10 is obtained by cutting a wafer having a plurality of LED chips formed thereon into rectangular parallelepiped pieces of given dimensions. The semiconductor light-emitting device measurement apparatus 100 of this embodiment is also capable of measuring optical characteristics and electric characteristics on the wafer and performing a process of removing a part of the resistive layer, or measuring the optical characteristics and electric characteristics of each of a plurality of the LED chips 10 mounted on a sheet and performing a process of removing a part of the resistive layer.

In FIG. 2, 1 represents a sapphire substrate. The sapphire substrate 1 (hereinafter referred to as the “substrate”) has a rectangular shape in a plan view and dimensions of about 0.3 mm in length and width, for example, but the dimensions are not limited to these values.

The LED chip 10 has a semiconductor layer (LED structure) formed by stacking an n-type semiconductor layer 2 for light emission, an active layer (not shown), and a p-type semiconductor layer 3 on the rectangular substrate 1.

A current diffusion layer 4 is formed on the surface of the p-type semiconductor layer 3 of the semiconductor layer (LED structure). The current diffusion layer 4 is, for example, an ITO film (indium tin oxide film) as a conductive transparent film. A bonding electrode 61 is formed on the surface of the current diffusion layer 4. The p-type semiconductor layer 3 is electrically connected to the bonding electrode 61 through the current diffusion layer 4.

An n-type semiconductor layer 2 as a resistive layer is formed on the substrate 1 so that it is separated from the n-type semiconductor layer 2 of the semiconductor layer (LED structure) for light emission. An n-ohmic electrode (not shown) is formed on the surface of the n-type semiconductor layer 2 as a resistive layer. A bonding electrode 62 is formed on the surface of the n-ohmic electrode. The n-type semiconductor layer 2 as a resistive layer is electrically connected to the bonding electrode 62 through the n-ohmic electrode.

The ohmic electrode (not shown) formed on the surface of the n-type semiconductor layer 2 as a resistive layer and an ohmic electrode (not shown) formed on the surface of the n-type semiconductor layer 2 as a semiconductor layer (LED structure) for light emission are connected with a wiring layer 63. The wiring layer 63 includes wiring layers 631, 632 and 633 arranged parallel to each other with an appropriate distance between them.

In short, the n-type semiconductor layer 2 as a resistive layer has a suitable width and is arranged along one side of the substrate 1. The bonding electrode 62 is formed near one end of the n-type semiconductor layer 2 (resistive layer). The wiring layers 631, 632, and 633 are connected through the n-ohmic electrode to the n-type semiconductor layer 2 (resistive layer) at a plurality of positions, respectively, which are separated by different distances from the bonding electrode 62, in a manner that they are electrically isolated from each other.

A protection film (not shown) is formed on parts of the side surfaces and top surfaces of the n-type semiconductor layer 2, p-type semiconductor layer 3, current diffusion layer 4, wiring layer 63 etc. which are not electrically connected. The protection film is, for example, a SiO2 film.

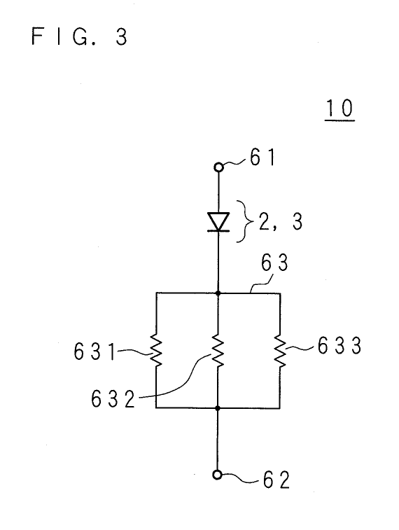

FIG. 3 is an explanatory view illustrating the circuit structure of the LED chip 10. As illustrated in FIG. 3, the LED chip 10 has the circuit structure in which the bonding electrode 61 is connected to the anode side of the semiconductor layers (2 and 3), one end of each of the wiring layers 631, 632, and 633 is connected through the wiring layer 63 to the cathode side of the semiconductor layers (2 and 3), and the bonding electrode 62 is connected to the other end of the wiring layers 631, 632, and 633. In FIG. 3, for the sake of convenience, the wiring layers 631, 632, and 633 and the n-type semiconductor layer 2 (resistive layer) connected to the wiring layers 631, 632, and 633 are collectively indicated as a resistive device.

Next, the following will explain the removal process to be performed by the semiconductor light-emitting device measurement apparatus 100 of this embodiment. In FIG. 2, a rectangular area 20 represents a removed portion of the surface of the LED chip 10 removed (cut) by laser light from the laser light source 33. In other words, in the example in FIG. 2, among the wiring layers 631, 632 and 633, only the wiring layer 633 is left and other wiring layers 631 and 632 are removed by the laser light. Removal by laser light is performed until the substrate 1 is exposed.

As illustrated in FIG. 2, by leaving any (the wiring layer 633 in the example in FIG. 2) of the wiring layers located at different distances from the bonding electrode 62 and removing the other wiring layers (the wiring layers 631 and 633 in the example in FIG. 2), a dimension of the resistive layer between the bonding electrode 62 and the portion where the wiring layer 633 is connected is selected, and a resistance of the resistive layer is set. Thus, the resistance of the resistive layer is set to a desired value, the resistance in the LED chip 10 is adjusted at the stage of measurement of optical characteristics or electric characteristics of the LED chip 10, and the optical characteristics and electric characteristics of the LED chip 10 are adjusted to desired values.

Although the example in FIG. 2 illustrates the structure where the wiring layer 633 is left and other wiring layers 631 and 632 are removed, the present invention is not limited to this. For instance, it is possible to leave the wiring layer 631 and remove other wiring layers 632 and 633, or leave the wiring layer 632 and remove other wiring layers 631 and 633. The number of wiring layers to be left without being removed is not limited to one and can be two. A structure without removing the wiring layers is also possible. Further, the number of the wiring layers 631 to 633 provided separately from each other is not limited to three, it can be two or four. Thus, with some different embodiments, it is possible to set the resistance value of the internal resistance of the LED chip 10 to a desired value.

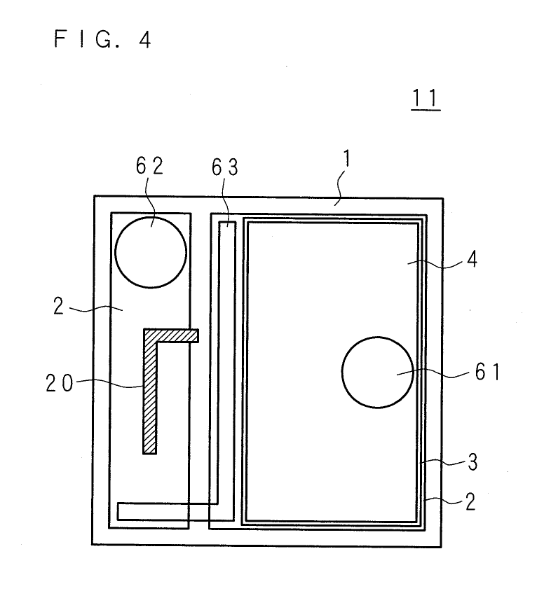

FIG. 4 is a schematic view illustrating another example of the planar structure of the LED chip 11. As illustrated in FIG. 4, the LED chip 11 has a semiconductor layer (LED structure) formed by stacking an n-type semiconductor layer 2 for light emission, an active layer (not shown), and a p-type semiconductor layer 3 on a rectangular substrate 1.

A current diffusion layer 4 is formed on the surface of the p-type semiconductor layer 3 of the semiconductor layer (LED structure). A bonding electrode 61 is formed on the surface of the current diffusion layer 4. The p-type semiconductor layer 3 is electrically connected to the bonding electrode 61 through the current diffusion layer 4.

An n-ohmic electrode (not shown) for connecting to a wiring layer 63 is formed on the surface of the n-type semiconductor layer 2 of the semiconductor layer (LED structure).

An n-type semiconductor layer 2 as a resistive layer is formed on the substrate 1 so that it is separated from the n-type semiconductor layer 2 of the semiconductor layer (LED structure) for light emission.

The n-type semiconductor layer 2 as a resistive layer has a suitable width and is arranged along one side of the substrate 1. A bonding electrode 62 is formed near one end of the n-type semiconductor layer 2 (resistive layer). A portion near the other end of the n-type semiconductor layer 2 (resistive layer) is connected through the wiring layer 63 to the n-type semiconductor layer 2 of the semiconductor layer for light emission.

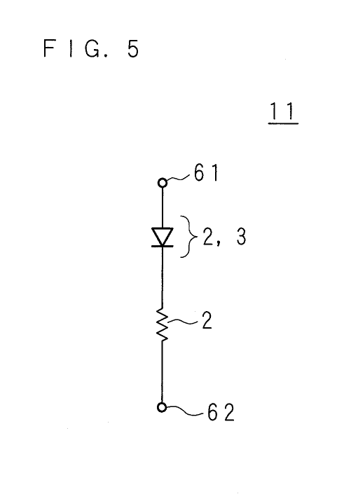

FIG. 5 is an explanatory view illustrating the circuit structure of the LED chip 11. As illustrated in FIG. 5, the LED chip 11 has a circuit structure in which the bonding electrode 61 is connected to the anode side of the semiconductor layers (2 and 3), one end of a resistive device (resistive layer) is connected through the wiring layer 63 to the cathode side of the semiconductor layers (2 and 3), and the bonding electrode 62 is connected to the other end of the resistive device (resistive layer).

Next, the following will explain the removal process to be performed by the semiconductor light-emitting device measurement apparatus 100 of this embodiment. In FIG. 4, a substantially L-shaped area 20 in the plan view represents a removed portion of the surface of the LED chip 10 which was removed by laser light from the laser light source 33. In other words, in the example in FIG. 4, suppose that a lengthwise direction is along the direction from the bonding electrode 62 to the connected section with the wiring layer 63 and a width direction is a direction perpendicular to the lengthwise direction, a part of the n-type semiconductor layer 2 as a resistive layer is removed halfway along the width direction and then removed along the lengthwise direction. The removal of the n-type semiconductor layer 2 (resistive layer) is carried out until the substrate 1 is exposed. Thus, with the adjustment of the length and the sectional area of the n-type semiconductor layer 2 (resistive layer), the resistance of the resistive layer is set in a wide range and further set to a desired value by making a fine adjustment. The resistance of the resistive layer is set to a desired value, the resistance in the LED chip 11 is adjusted at the stage of measurement of optical characteristics or electric characteristics of the LED chip 11, and the optical characteristics and electric characteristics of the LED chip 11 are set to desired values.

Note that, in the example in FIG. 4, although the removed area 20 has an L-shape in the plan view, the shape of the area to be removed is not limited to the L-shape. It is possible to remove an area of any shape according to a desired resistance.

The semiconductor light-emitting device measurement apparatus 100 comprises the laser light source 33 for removing a part of the surfaces of the LED chips 10 and 11. By removing a part of the wiring layers (631 to 633) of the LED chip 10 or the resistive layer of the LED chip 11 with laser light from the laser light source 33, the internal resistances of the LED chips 10 and 11 are changed, a current flowing in the semiconductor layer is adjusted, and the quantity of light to be emitted from the LED chips 10 and 11 is also adjusted. It is thus possible to change the optical characteristics or electric characteristics of the LED chips 10 and 11.

Moreover, the semiconductor light-emitting device measurement apparatus 100 comprises the position adjusting section 38 for adjusting the position to be removed by laser light from the laser light source 33 on the basis of optical characteristics (such as, for example, brightness) measured by the optical characteristic measuring section 36. For instance, when the quantity of light from the LED chips 10 and 11 is large (brightness is high), the position to be removed by the laser light is changed to increase the internal resistances in the LED chips 10 and 11, and consequently the current flowing in the semiconductor layer is reduced and the quantity of light (brightness) is decreased. It is thus possible to change the characteristics while measuring the characteristics of the LED chips 10 and 11.

With the position adjusting section 38, it is possible to remove a desired position on the surfaces of the LED chips 10 and 11. Similarly, with the use of a movable mirror, it is possible to remove a desired position on the surfaces of the LED chips 10 and 11.

The semiconductor light-emitting device measurement apparatus 100 comprises the microcomputer 30 for determining whether or not the difference between an optical characteristic (such as brightness) measured by the optical characteristic measuring section 36 and a given target value is within a threshold. When the microcomputer 30 determines that the difference is not within the threshold, the position adjusting section 38 moves the movable stage 31 to adjust the position to be removed according to the difference under the control of the microcomputer 30. The laser light source 33 removes a part of the surfaces of the LED chips 10 and 11, according to the position adjusted by the position adjusting section 38. When the microcomputer 30 determines that the difference is within the threshold, removing is finished. For instance, before removing any of the wiring layers (631-633) or a part of the resistive layer 2 with the laser light source 33, when optical characteristics (such as, for example, brightness) of the LED chips 10 and 11 are measured, and if the difference between the measured brightness and a target value (for example, 100 mcd) exceeds a threshold, the position to be removed is adjusted according to the difference. The adjustment of the position means adjusting, for example, the length or the area of a portion to be removed, or the number of portions to be removed. When the difference between the measured brightness and the target value falls within the threshold, removing is finished. It is thus possible to set characteristics of the LED chips 10 and 11 to desired values.

In addition, the semiconductor light-emitting device measurement apparatus 100 comprises the stratification section 39 for stratifying the LED chips 10 and 11 on the basis of the optical characteristics measured by the optical characteristic measuring section 36. Therefore, even when the optical characteristics are changed while measuring the optical characteristics, the LED chips 10 and 11 with similar optical characteristics are classified into one group, while the LED chips 10 and 11 with different optical characteristics are distinguished.

### Embodiment 2

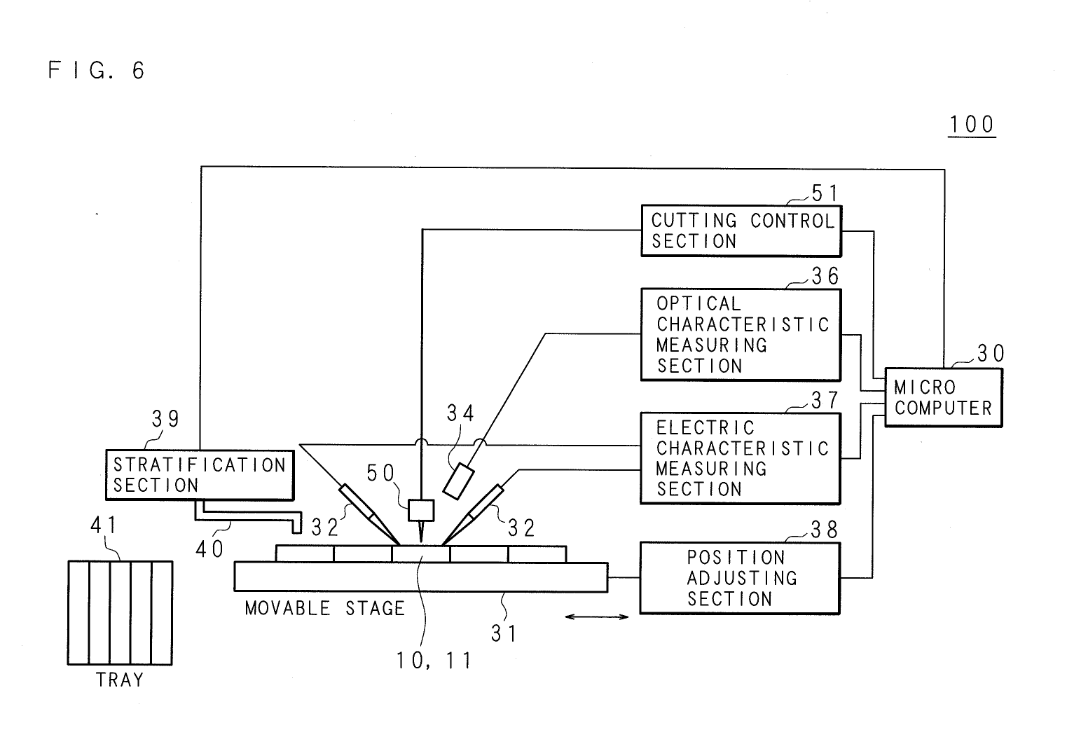

FIG. 6 is a block diagram illustrating one example of the configuration of a semiconductor light-emitting device measurement apparatus 100 according to Embodiment 2. The difference from Embodiment 1 is that the semiconductor light-emitting device measurement apparatus 100 comprises a cutting tool 50 and a cutting control section 51, instead of the laser light source 33 and the laser control section 35.

The cutting tool 50 is a machinery tool. For example, it is possible to use a ultra-steel cutting tool, but the cutting tool 50 is not limited to this, and a general cutting tool can be used.

The cutting control section 51 controls ON/OFF of the cutting tool 50. Note that the position of a portion of the LED chips 10 and 11 to be removed can be adjusted by moving the cutting tool 50, instead of moving the movable stage 31.

Other structures are the same as in Embodiment 1, and therefore explanation thereof will be omitted. The same functions and effects as in Embodiment 1 are also exhibited.

As described above, in Embodiments 1 and 2, it is possible to change characteristics (optical characteristics and electric characteristics) of LED chips after forming electrodes of the LED chips, and it is also possible to efficiently manufacture LED chips with desired characteristics by executing the measurement of characteristics and the removal process (work) at the same time.

As this description may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A semiconductor light-emitting device measurement apparatus having a measuring section for detecting light from a semiconductor light-emitting device and measuring optical characteristics, comprising a removal processing section for removing a part of a surface of the semiconductor light-emitting device.

2. The semiconductor light-emitting device measurement apparatus of claim 1, further comprising a position adjusting section for adjusting, based on optical characteristics measured by the measuring section, a position to be removed by the removal processing section.

3. The semiconductor light-emitting device measurement apparatus of claim 2, further comprising a determination section for determining whether or not a difference between an optical characteristic measured by the measuring section and a given target value is within a threshold,
wherein, when the determination section determines that the difference is not within the threshold, the position adjusting section adjusts the position to be removed, according to the difference, and
the removal processing section removes a part of a surface of the semiconductor light emitting device, according to the position adjusted by the position adjusting section, and finishes removing when the determination section determines that the difference is within the threshold.

4. The semiconductor light-emitting device measurement apparatus of claim 1,
wherein the removal processing section removes any of a plurality of wiring layers connecting a semiconductor light-emitting layer of the semiconductor light-emitting device and a resistive layer formed to be connected in series with the semiconductor light-emitting layer.

5. The semiconductor light-emitting device measurement apparatus of claim 1,
wherein the removal processing section removes a part of a resistive layer formed to be connected in series with a semiconductor light-emitting layer of the semiconductor light-emitting device.

6. The semiconductor light-emitting device measurement apparatus of claim 2,
wherein the removal processing section is a laser light source for irradiating laser light.

7. The semiconductor light-emitting device measurement apparatus of claim 6,
wherein the position adjusting section is a movable mirror for adjusting an irradiation direction of laser light, or a movable base for placing the semiconductor light-emitting device thereon.

8. The semiconductor light-emitting device measurement apparatus of claim 2,
wherein the removal processing section is a cutting tool having a cutting needle.

9. The semiconductor light-emitting device measurement apparatus of claim 8,
wherein the position adjusting section is a movable base for placing the semiconductor light-emitting device thereon.

10. The semiconductor light-emitting device measurement apparatus of claim 1, further comprising a stratification section for stratifying the semiconductor light-emitting device, based on optical characteristics measured by the measuring section.
